(19) United States
(12) Patent Application Publication
(10) Pub. No.: US 2015/0344349 A1
(43) Pub. Date: Dec. 3, 2015

(54) METHOD FOR MANUFACTURING GLASS MATERIAL

(71) Applicants: NIPPON ELECTRIC GLASS CO., LTD., Otsu-shi, Shiga (JP); THE UNIVERSITY OF TOKYO, Bunkyo-ku, Tokyo (JP)

(72) Inventors: Fumio SATO, Otsu-shi (JP); Tomoko YAMADA, Otsu-shi (JP); Osamu ODANI, Otsu-shi (JP); Hiroyuki INOUE, Bunkyo-ku (JP); Atsunobu MASUNO, Bunkyo-ku (JP)

(21) Appl. No.: 14/653,415

(22) PCT Filed: Dec. 6, 2013
(86) PCT No.: PCT/JP2013/082789

§ 371 Date: Jun. 18, 2015

(30) Foreign Application Priority Data
Dec. 28, 2012 (JP) 2012-286527
Sep. 27, 2013 (JP) 2013-201851

(51) Int. Cl. C03B 40/04; C03B 23/00

(52) U.S. Cl. CPC C03B 40/04; C03B 23/00

(57) ABSTRACT

Provided is a method that can manufacture a large-sized glass material by containerless levitation. A glass raw material block (13) is placed on a forming surface (11a) having a plurality of gas jet holes (12a) opened thereto, gas is jetted through the plurality of gas jet holes (12a) to hold the glass raw material block (13) levitated above the forming surface (11a), and the glass raw material block (13) held levitated above the forming surface (11a) is melted by heat and then cooled to obtain a glass material.

### TECHNICAL FIELD

This invention relates to a method for manufacturing a glass material.

### BACKGROUND ART

In recent years, studies on containerless levitation techniques as methods for manufacturing glass materials are being conducted. For example, Patent Literature 1 describes a method in which a barium-titanium-based ferroelectric sample levitated in an aerodynamic levitation furnace is melted by heat generated by irradiation with a laser beam and then cooled to vitrify. In such a manner, containerless levitation techniques can prevent the progress of crystallization due to contact of the melt with the wall surface of a container. Therefore, materials that could not be vitrified by conventional manufacturing methods using a container can be vitrified by containerless levitation techniques. Hence, containerless levitation techniques are noteworthy as methods that can manufacture glass materials having novel compositions.

### CITATION LIST

### Patent Literature

### [PTL 1]

JP-A-2006-248801

### SUMMARY OF INVENTION

### Technical Problem

The method described in Patent Literature 1, however, has difficulty manufacturing a large-sized glass material.

A principal object of the present invention is to provide a method that can manufacture a large-sized glass material by containerless levitation.

### Solution to Problem

In a method for manufacturing a glass material according to the present invention, a glass raw material block is placed on a forming surface having a plurality of gas jet holes opened thereto, gas is jetted through the plurality of gas jet holes to hold the glass raw material block levitated above the forming surface, and the glass raw material block held levitated above the forming surface is melted by heat and then cooled to obtain a glass material.

In the method for manufacturing a glass material according to the present invention, the gas jet holes in the forming surface are preferably arranged in a plurality of lines extending outward from a center side of the forming surface. The gas jet holes are more preferably provided radially in the forming surface.

In the method for manufacturing a glass material according to the present invention, the gas jet holes in the forming surface are preferably provided so that centers of the gas jet holes are located at each vertex of an equilateral triangle grid.

In the method for manufacturing a glass material according to the present invention, the gas jet holes preferably have a diameter of 1 mm or less.

In the method for manufacturing a glass material according to the present invention, a forming die having the forming surface may include a porous body having interconnected pores and the gas jet holes may be formed of the interconnected pores. In this case, it is preferred to use as the forming die a forming die including the porous body and a gas barrier layer covering a lateral surface of the porous body.

In the method for manufacturing a glass material according to the present invention, the forming surface is preferably provided in a concave spherical or concave aspherical shape having a central angle of 180° or less.

In the method for manufacturing a glass material according to the present invention, a proportion of area of the forming surface occupied by the gas jet holes is preferably 0.1% or more.

In the method for manufacturing a glass material according to the present invention, the gas jet holes are preferably provided only in a central region of the forming surface.

In the method for manufacturing a glass material according to the present invention, the gas jet holes in a central region of the forming surface are preferably provided so that centers of the gas jet holes are located at each vertex of an equilateral triangle grid and the gas jet holes outside the central region of the forming surface are preferably provided radially.

### Advantageous Effects of Invention

The present invention can provide a method that can manufacture a large-sized glass material by containerless levitation.

### BRIEF DESCRIPTION OF DRAWINGS

FIG. 1 is a schematic cross-sectional view of a forming die for use in one embodiment of the present invention.

FIG. 2 is a schematic plan view of a portion of a forming surface in the one embodiment of the present invention.

FIG. 3a is a schematic plan view of a portion of a forming surface in another embodiment of the present invention. FIG. 3b is a schematic plan view for illustrating an arrangement of gas jet holes in the forming surface of FIG. 3a.

FIG. 4 is a schematic cross-sectional view of a forming die for use in still another embodiment of the present invention.

FIG. 5 is a schematic plan view of a portion of a forming surface in still another embodiment of the present invention.

FIG. 6 is a schematic cross-sectional view for illustrating a method for manufacturing a glass material in the one embodiment of the present invention.

FIG. 7 is a schematic cross-sectional view of a forming die for use in a modification.

### DESCRIPTION OF EMBODIMENTS

Hereinafter, a description will be given of exemplary preferred embodiments for working of the present invention. However, the following embodiments are merely illustrative. The present invention is not at all limited to the following embodiments.

Throughout the drawings to which the embodiments and the like refer, elements having substantially the same functions will be referred to by the same reference signs. The drawings to which the embodiments and the like refer are schematically illustrated. The dimensional ratios and the like of objects illustrated in the drawings may be different from those of the actual objects. Different drawings may have different dimensional ratios and the like of the objects. Dimensional ratios and the like of specific objects should be determined in consideration of the following descriptions.

In this embodiment a description will be given of a method for manufacturing a glass material, such as a network forming oxide-free glass material, having a composition that could not be vitrified by melting methods using a container. Specifically, the method for manufacturing a glass material described in this embodiment is suitably used in manufacturing, for example, barium titanate-based glass materials, lanthanum-niobium composite oxide-based glass materials, lanthanum-niobium-aluminum composite oxide-based glass materials, lanthanum-niobium-tantalum composite oxide-based glass materials, lanthanum-tungsten composite oxide-based glass materials, and so on.

(Structure of Forming Die 1)

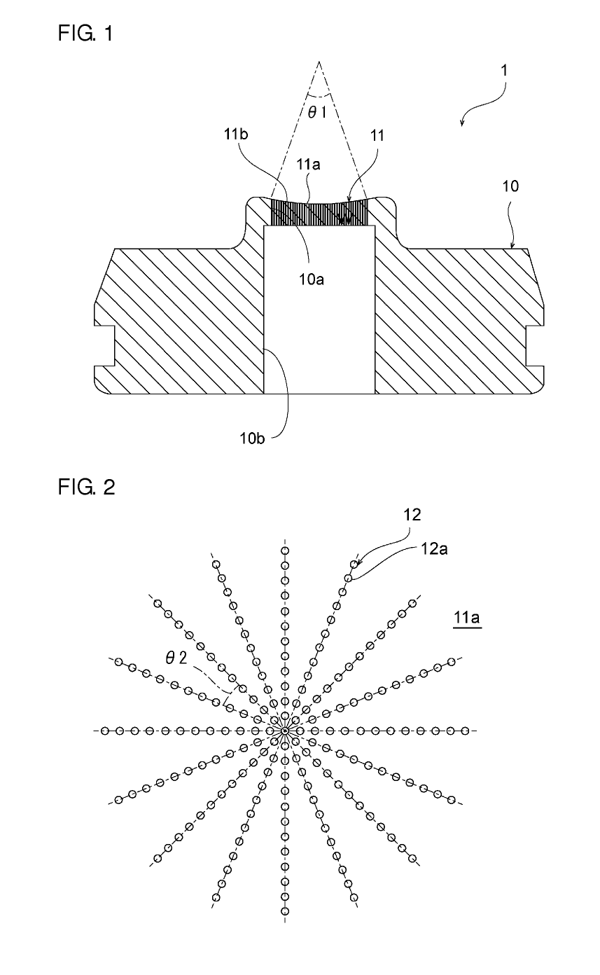

FIG. 1 is a schematic cross-sectional view of a forming die 1 for use in this embodiment. The forming die 1 includes a first die piece 10 and a second die piece 11. No particular limitation is placed on the constituent materials of the first and second die pieces 10, 11. The first and second die pieces 10, 11 can be constituted by, for example, silicon carbide, super steel, stainless steel, duralumin, carbon or so on.

The first die piece 10 is provided with an opening 10a. The second die piece 11 is inserted and fixed in this opening 10a. The first die piece 10 has a gas channel 10b formed therein to face the second die piece 11. This gas channel 10b is connected to a gas supply mechanism, such as a compressed gas cylinder. Gas is supplied from this gas supply mechanism via the gas channel 10b to the second die piece 11. No particular limitation is placed on the type of the gas. The gas may be, for example, air or oxygen or may be inert gas, such as nitrogen, argon or helium gas.

The second die piece 11 has a forming surface 11a. The forming surface 11a is provided opposite to the surface of the second die piece 11 facing the gas channel 10b. In this embodiment, the shape of the forming surface 11a in plan view is circular. The forming surface 11a is preferably provided in a concave spherical or concave aspherical shape. The forming surface 11a is provided in a concave spherical or concave aspherical shape having a central angle θ1 of, preferably 180° or less, more preferably 10° to 120°, still more preferably 30° to 115°, yet still more preferably 40 to 110°, or particularly preferably 60 to 100°. If the central angle of the concave spherical or concave aspherical surface forming the forming surface is too small, a glass raw material block may not be stably levitated. On the other hand, if the central angle of the concave spherical or concave aspherical surface forming the forming surface is too large, a glass raw material block which is not perfectly spherical might catch on the forming surface when trying to levitate, thus being restrained from levitation.

As shown in FIG. 2, the second die piece 11 is provided with a plurality of gas jet holes 12a. One ends of the plurality of gas jet holes 12a are connected to the gas channel 10b and the other ends thereof are opened to the forming surface 11a. In other words, the gas jet holes 12a connect the gas channel 10b and the forming surface 11a. Thus, gas supplied via the gas channel 10b to the second die piece 11 jets through the gas jet holes 12a from the forming surface 11a.

Specifically, the gas jet holes 12a in the forming surface 11a are arranged in a plurality of lines extending outward from a center side of the forming surface 11a (particularly, from the center thereof in this embodiment). More specifically, the plurality of gas jet holes 12a are provided radially in the forming surface 11a. Still more specifically, a plurality of gas jet hole rows 12, each row formed of a plurality of gas jet holes 12a aligned at intervals along the radial direction from the center of the forming surface 11a, are provided at regular intervals along the circumferential direction.

In FIG. 2, the center distance between the gas jet holes 12a adjacent to each other in the radial direction is preferably 0.02 mm to 2 mm and more preferably 0.1 mm to 0.2 mm. The angle θ2 formed by the directions of alignment of the gas jet hole rows 12 adjacent to each other in the circumferential direction is preferably 5° to 45° and more preferably 10° to 25°. In other words, the number of gas jet hole rows 12 provided is preferably 8 to 72 and more preferably 14 to 36.

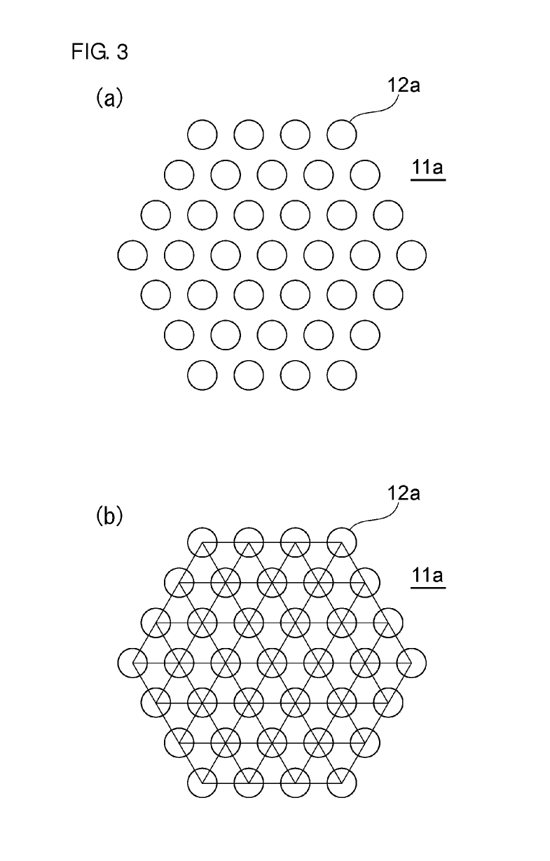

FIG. 3a shows a schematic plan view of a portion of a forming surface in another embodiment of the present invention. In the forming surface 11a, a plurality of gas jet holes 12a are densely provided so that each adjacent pair of gas jet holes 12a are spaced an equal distance from each other. In other words, as shown in FIG. 3b, the plurality of gas jet holes 12a are provided so that their centers are located at each vertex of an equilateral triangle grid (hereinafter, the arrangement of the gas jet holes 12a in FIG. 3 is referred to as a “closely arranged configuration” for convenience). In FIG. 3, the center distance between the gas jet holes 12a adjacent to each other is preferably 0.02 mm to 2 mm, more preferably 0.1 mm to 1 mm, and still more preferably 0.2 mm to 0.8 mm.

The diameter of the gas jet holes 12a is preferably not more than 1 mm, more preferably not more than 0.5 mm, and still more preferably not more than 0.3 mm. However, if the diameter of the gas jet holes 12a is too small, gas may be difficult to jet through the gas jet holes 12a. Therefore, the diameter of the gas jet holes 12a is preferably not less than 0.01 mm and more preferably not less than 0.05 mm.

The proportion of the area of the forming surface 11a occupied by the gas jet holes 12a (i.e., (the total area of the gas jet holes 12a)/(the area of the forming surface 11a)) is preferably not less than 0.1%, more preferably not less than 1.0%, and still more preferably not less than 10%. However, if the proportion of the area of the forming surface 11a occupied by the gas jet holes 12a is too large, the glass raw material block may not be stably levitated. Therefore, the proportion of the area of the forming surface 11a occupied by the gas jet holes 12a is preferably not more than 50%, more preferably not more than 30%, and still more preferably not more than 20%.

The number of gas jet holes 12a provided is preferably five or more, more preferably 10 or more, still more preferably 100 or more, yet still more preferably 250 or more.

The plurality of gas jet holes 12a may include a plurality of types of gas jet holes 12a having different diameters.

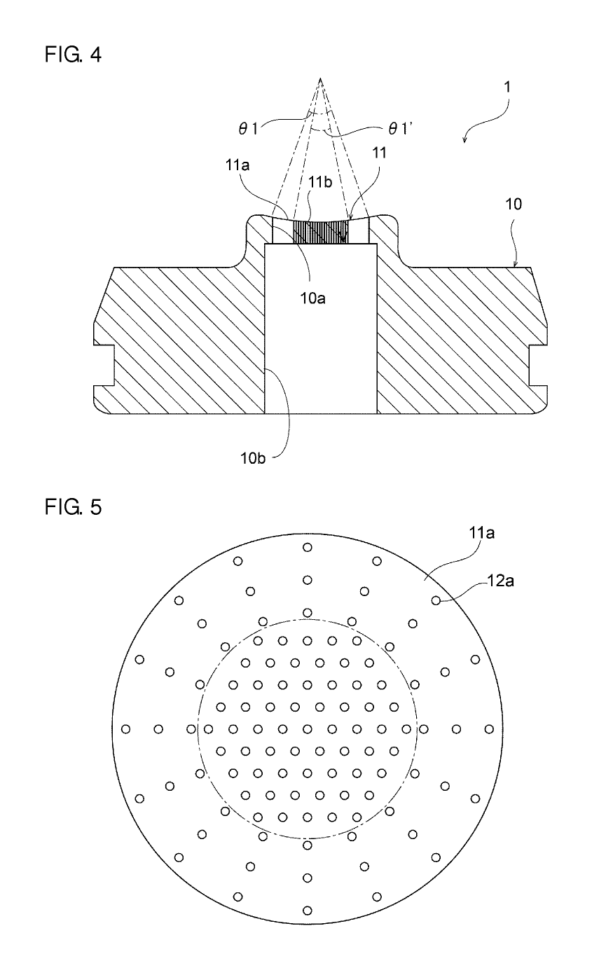

Although in FIG. 1 the entire forming surface 11a is formed of a gas jet hole formed surface 11b, only a central region of the forming surface 11a may be formed of a gas jet hole formed surface 11b as shown in FIG. 4. In this case, the ratio θ1′/θ1 of the central angle θ1′ of the gas jet hole formed surface 11b to the central angle θ1 of the forming surface 11a is preferably 0.3 to 0.8 and more preferably 0.4 to 0.7. The restriction of θ1′/θ1 in the above manner stabilizes the levitating state of the glass raw material block 13 and thus enables the provision of a larger-sized glass material, although a detailed mechanism thereof is not clear.

Alternatively, the gas jet holes 12a may be arranged relatively densely in the central region of the forming surface 11a but relatively sparsely in a region of the forming surface 11a outside the central region thereof. A specific example of the above arrangement is, as shown in FIG. 5, a configuration in which the gas jet holes 12a in the central regions of the forming surface 11a have a closely arranged configuration and the gas jet holes 12a in the region of the forming surface 11a outside of the central region are provided radially. Another example of the above arrangement is a configuration in which the gas jet holes 12a in a central region of the forming surface 11a have a relatively dense closely arranged configuration and the gas jet holes 12a in the region of the forming surface 11a outside the central region have a relatively sparse closely arranged configuration.

(Method for Manufacturing Glass Material)

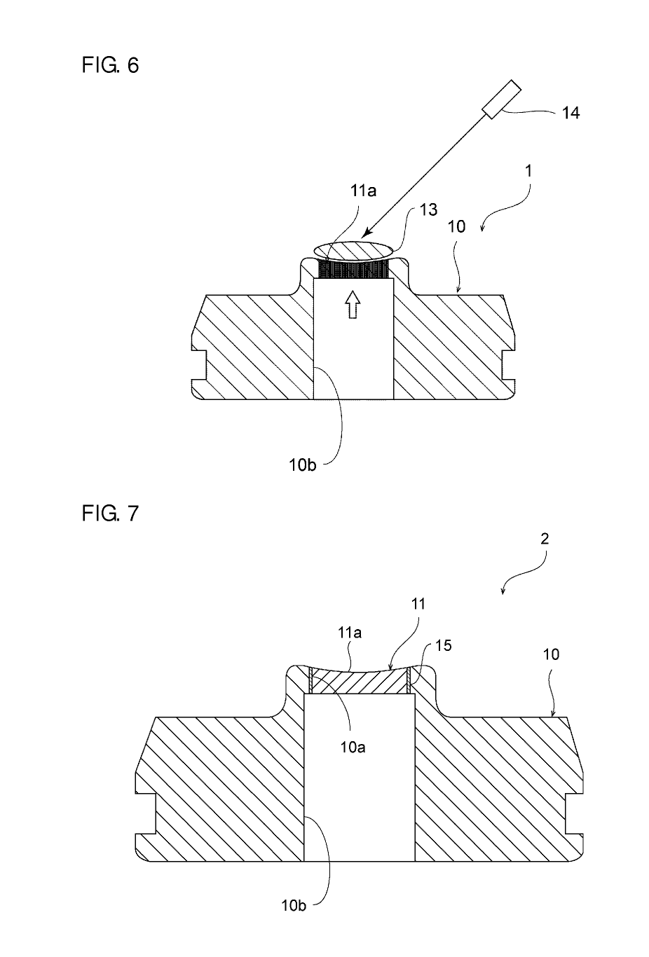

Next, a description will be given of a method for manufacturing a glass material. First, a glass raw material block 13 shown in FIG. 6 is prepared. The glass raw material block 13 is, for example, one obtained by blending and mixing raw material powders for a glass material and forming the resultant powder mixture in a single piece by press forming or so on. The glass raw material block 13 may be obtained by, after the press forming of the powder mixture, subjecting it to a heat treatment process, such as firing or laser irradiation. Alternatively, a crystalline body having the same composition as a desired glass composition may be used as the glass raw material block 13.

Next, the glass raw material block 13 is placed on the forming surface 11a and gas is supplied into the gas channel 10b to jet out the gas through the plurality of gas jet holes 12a, thus holding the glass raw material block 13 levitated above the forming surface 11a. In other words, the glass raw material block 13 is held above and not in contact with the forming surface 11a. In this state, the glass raw material block 13 is melted by heat generated by irradiation with laser light from a laser applicator 14 to make it vitrifiable and then cooled, thus obtaining a glass material. At least during the process of melting the glass raw material block 13 by heat and the process of cooling the glass material at least to below the softening point, the jetting of gas is continued to avoid the contact of the glass raw material block 13 or the glass material with the forming surface 11a.

The method for heating the glass raw material block 13 is not particularly limited to the method of irradiating it with laser light. For example, the glass raw material block 13 may be heated by radiant heat.

In melting a glass raw material block while holding it levitated, it is common to form the forming surface in the shape of a deep bowl and provide a single gas jet hole in the center of the forming surface. This is attributed to the view that when a single gas jet hole is provided in the center of the forming surface, gas flows between the forming surface and the glass raw material block, thus making the contact of the forming surface with the glass raw material block difficult. However, intensive studies by the present inventors have revealed that when a single gas jet hole is provided in the center of the forming surface, this cannot sufficiently prevent the contact of the forming surface with the glass raw material block. The reason for this is not clear but can be considered as follows. For example, it can be considered that if the centroid of the glass raw material block coincides with the position of the gas jet hole, gas jetted through the gas jet hole flows evenly over the surface of the glass raw material block, so that the glass raw material block is less likely to be displaced even during flowing of the gas. In practice, however, it is unlikely that the centroid of the glass raw material block always coincides with the position of the gas jet hole. For example, during melting of the glass raw material block, the centroid of the glass raw material block may change. Therefore, actually, it is likely that the centroid of the glass raw material block does not coincide with the position of the gas jet hole. When the centroid of the glass raw material block does not coincide with the position of the gas jet hole, the amount of gas flow varies around the glass raw material block. Also, when the glass raw material block is not perfectly spherical, the amount of gas flow varies around the glass raw material block even if the centroid of the glass raw material block coincides with the position of the gas jet hole. The variations in amount of gas flow make it likely to displace the glass raw material block and bring the glass raw material block into contact with the forming surface. Furthermore, when the glass raw material block becomes larger, the variations in gas flow make it likely to displace the glass raw material block to a greater extent. This makes it easier to cause the contact of the glass raw material block with the forming surface. Hence, when a single gas jet hole is provided in the center of the forming surface, a large-sized glass material is difficult to obtain.

Unlike the above, in this embodiment, a plurality of gas jet holes 12a are provided. Therefore, even if the centroid of the glass raw material block 13 changes, the gas flow and gas convection flow are less likely to change. Thus, even when the glass raw material block 13 has a large size, the glass raw material block 13 is less likely to come into contact with the forming surface 11a. Therefore, in the manufacturing method of this embodiment, even when the glass raw material block 13 has a large size, the glass raw material block 13 is less likely to be displaced and come into contact with the forming surface 11a. Hence, even from compositions that cannot be vitrified by melting processes using a container, a large-sized glass material, for example, with a diameter of 2 mm or more, can be manufactured.

Furthermore, when a single gas jet hole is provided in the center of the forming surface, gas jetted through the gas jet hole flows in a nearly ordered flow around the glass raw material block. In contrast, when a plurality of gas jet holes 12a are provided, gas streams jetted through adjacent gas jet holes 12a collide, so that disturbed flows are likely to occur. Thus, a gas retention layer is likely to occur between the forming surface 11a and the glass raw material block 13. Therefore, also in this viewpoint, it can be considered that the provision of a plurality of gas jet holes 12a can prevent the glass raw material block 13 from coming into contact with the forming surface 11a.

In addition, since the provision of a plurality of gas jet holes 12a makes it likely to create a gas retention layer, this can reduce the amount of gas flow required to levitate the glass raw material block 13. Therefore, it is also possible to prevent the glass raw material block 13 from being undesirably cooled by the gas.

From the viewpoint of making it easier to create a gas retention layer, it is preferred that the gas jet holes 12a in the forming surface 11a should be arranged in a plurality of lines extending outward from the center side of the forming surface 11a and it is more preferred that the plurality of gas jet holes 12a should be provided radially in the forming surface 11a. Furthermore, the diameter of the gas jet holes 12a is preferably not more than 1 mm and more preferably not more than 0.5 mm. Moreover, the forming surface 11a is preferably formed of a concave spherical or concave aspherical surface having a central angle of 120° or less and more preferably formed of a concave spherical or concave aspherical surface having a central angle of 115° or less.

The gas may be supplied into the plurality of gas jet holes 12a so that the amount of gas jetted varies among the gas jet holes 12a.

(Modification)

FIG. 7 is a schematic cross-sectional view of a forming die 2 for use in a modification. In the forming die 2, the second die piece 11 is made of a porous body having interconnected pores. In this modification, the gas jet holes are constituted by the interconnected pores in the second die piece 11. Also in this case, substantially the same effects as in the above embodiment can be achieved.

If the second die piece 11 is made of a porous body having interconnected pores, a gas barrier layer 15 covering a lateral surface of the second die piece 11 is preferably provided. The provision of the gas barrier layer 15 can prevent the gas from leaking from the lateral surface of the second die piece 11. Thus, the amount of gas jetted from the forming surface 11a can be increased. The gas barrier layer 15 can be made of, for example, metal, ceramic or glass. The gas barrier layer 15 may be formed by glass coating.

Furthermore, at least a portion of the forming die may be made of a porous body having interconnected pores and additional gas jet holes may be formed in the porous body.

The present invention will be described below in more detail with reference to specific examples but the present invention is not at all limited by the following examples. Modifications and variations may be appropriately made therein without changing the gist of the present invention.

### Example 1

First, raw material powders were weighed and mixed and the powder mixture was calcined at a temperature around 1000° C. and thus sintered. An amount of piece having a desired volume was cut out of the sintered body, thus preparing a glass raw material block. Next, under the conditions described below, the glass raw material block was, while being held levitated above the forming surface, melted by heat generated by irradiation with carbon dioxide laser at an output power of 100 W. Thereafter, the laser irradiation was stopped to cool the raw glass material block. As a result, a glass material with a diameter of 4.51 mm was obtained.

The glass composition (molar ratio): 0.3La₂O₃-0.7Nb₂O₅

The diameter of gas jet holes: 0.1 mm

The diameter of the forming surface in plan view: 6 mm

The number of gas jet holes: 185

The proportion of the area of the forming surface occupied by gas jet holes: 5.1%

The central angle θ1 of the forming surface: 28°

The angle θ2 formed by the directions of alignment of gas jet hole rows: 22.5°

The center distance between gas jet holes adjacent in the radial direction: 0.2 mm

The heating temperature: 2000° C.

The gas used: air

### Example 2

The same manufacturing process as in Example 1 was performed except for the following conditions. As a result, a glass material with a diameter of 7.65 mm was obtained.

The glass composition (molar ratio): 0.2La₂O₂-0.8WO₂

The diameter of gas jet holes: 0.1 mm

The diameter of the forming surface in plan view: 10 mm

The number of gas jet holes: 649

The proportion of the area of the forming surface occupied by gas jet holes: 6.5%

The central angle θ1 of the forming surface: 37°

The angle θ2 formed by the directions of alignment of gas jet hole rows: 11.25°

The center distance between gas jet holes adjacent in the radial direction: 0.2 mm

The heating temperature: 1500° C.

The gas used: nitrogen gas

### Example 3

The same manufacturing process as in Example 1 was performed except for the following conditions. As a result, a glass material with a diameter of 10.55 mm was obtained.

The glass composition (molar ratio): 0.33BaO-0.66TiO₂

The diameter of gas jet holes: 0.1 mm

The diameter of the forming surface in plan view: 13 mm

The number of gas jet holes: 905

The proportion of the area of the forming surface occupied by gas jet holes: 4.0%

The central angle θ1 of the forming surface: 35°

The angle θ2 formed by the directions of alignment of gas jet hole rows: 11.25°

The center distance between gas jet holes adjacent in the radial direction: 0.2 mm

The heating temperature: 2100° C.

The gas used: argon gas

### Example 4

The same manufacturing process as in Example 1 was performed except for the following conditions. As a result, a glass material with a diameter of 12.35 mm was obtained.

The glass composition (molar ratio): 0.4La₂O₃-0.3Nb₂O₅-0.3Al₂O₃

The diameter of gas jet holes: 0.3 mm

The diameter of the forming surface in plan view: 15 mm

The number of gas jet holes: 253

The proportion of the area of the forming surface occupied by gas jet holes: 10.5%

The central angle θ1 of the forming surface: 29°

The angle θ2 formed by the directions of alignment of gas jet hole rows: 11.25°

The center distance between gas jet holes adjacent in the radial direction: 0.6 mm

The heating temperature: 2050° C.

The gas used: air

### Example 5

The same manufacturing process as in Example 1 was performed except for the following conditions. As a result, a glass material with a diameter of 5.01 mm was obtained.

The glass composition (molar ratio): 0.6La₂O₃-0.2Nb₂O₅-0.2Ta₂O₅

The forming die: porous silicon carbide body

The diameter of the forming surface in plan view: 8 mm

The central angle θ1 of the forming surface: 52°

The heating temperature: 2150° C.

The gas used: air

### Example 6

The same manufacturing process as in Example 4 was performed except for the following conditions. As a result, a glass material with a diameter of 5.8 mm was obtained.

The glass composition (molar ratio): 0.6La₂O₃-0.2Nb₂O₅-0.2Ta₂O₅

The diameter of the forming surface in plan view: 14.7 mm

The number of gas jet holes: 413

The gas jet holes were arranged so as to have a closely arranged configuration in a central region of the forming surface having a diameter of 7.2 mm and provided, in a region of the forming surface outside the central region, so that the angle θ2 formed by the directions of alignment of gas jet hole rows was 11.25° (wherein the central angle θ1′ was 42°, θ1=91°, and θ1′/θ1=0.46).

The proportion of the area of the forming surface occupied by gas jet holes: 17.2%

### Example 7

The same manufacturing process as in Example 1 was performed except for the following conditions. As a result, a glass material with a diameter of 5.2 mm was obtained.

The glass composition (molar ratio): 0.4La₂O₃-0.3Nb₂O₅-0.3Al₂O₃

The diameter of gas jet holes: 0.3 mm

The diameter of the forming surface in plan view: 8 mm

The central angle θ1 of the forming surface: 53°

The number of gas jet holes: 253

The proportion of the area of the forming surface occupied by gas jet holes: 35.6%

The arrangement of gas jet holes: closely arranged configuration

The center distance between most close gas jet holes: 0.45 mm

The heating temperature: 2050° C.

### Example 8

The same manufacturing process as in Example 7 was performed except for the following conditions. As a result, a glass material with a diameter of 6.3 mm was obtained.

The glass composition (molar ratio): 0.3La₂O₃-0.6Nb₂O₅-0.1Al₂O₃

The diameter of the forming surface in plan view: 14.3 mm

The gas jet holes were provided only in a central region of the forming surface having a diameter of 7.6 mm (wherein the central angle θ1′ was 50.0°, θ1=73.6, and θ1′/θ1=0.68) and no gas jet hole was provided in a region of the forming surface outside the central region.

The number of gas jet holes: 93

The proportion of the area of the forming surface occupied by gas jet holes: 4.0%

The center distance between most close gas jet holes: 0.6 mm

The angle θ2 formed by the directions of alignment of gas jet hole rows: 11.25°

The gas used: oxygen

### Example 9

The same manufacturing process as in Example 7 was performed except for the following conditions. As a result, a glass material with a diameter of 12.5 mm was obtained.

The diameter of the forming surface in plan view: 15 mm

The gas jet holes were provided only in a central region of the forming surface having a diameter of 7.4 mm (wherein the central angle θ1′ was 43.2°, θ1=97.0°, and θ1′/θ1=0.45) and no gas jet hole was provided in a region of the forming surface outside the central region.

The number of gas jet holes: 253

The proportion of the area of the forming surface occupied by gas jet holes: 10.2%

The center distance between most close gas jet holes: 0.45 mm

The arrangement of gas jet holes: closely arranged configuration

### Example 10

The same manufacturing process as in Example 5 was performed except for the following conditions. As a result, a glass material with a diameter of 10.2 mm was obtained.

The glass composition (molar ratio): 0.3La₂O₃-0.7Al₂O₃

The diameter of the forming surface in plan view: 12 mm

The central angle θ1 of the forming surface: 119°

The gas used: oxygen

### Comparative Example

The same manufacturing process as in Example 1 was performed except for the use of a forming die in which a single gas jet hole having a diameter of 6 mm was provided to open at the center of a conical forming surface having a central angle of 60°. However, the glass raw material block could not be stably levitated, resulting in crystallization and failure to obtain a glass material.

### REFERENCE SIGNS LIST

1, 2 . . . forming die
10 . . . first die piece
10a . . . opening
10b . . . gas channel
11 . . . second die piece
11a . . . forming surface
11b . . . gas jet hole formed surface
12 . . . gas jet hole row
12a . . . gas jet hole
13 . . . glass raw material block
14 . . . laser applicator
15 . . . gas barrier layer

1. A method for manufacturing a glass material, wherein a glass raw material block is placed on a forming surface having a plurality of gas jet holes opened thereto, gas is jetted through the plurality of gas jet holes to hold the glass raw material block levitated above the forming surface, and the glass raw material block held levitated above the forming surface is melted by heat and then cooled to obtain a glass material.

2. The method for manufacturing a glass material according to claim 1, wherein the gas jet holes in the forming surface are arranged in a plurality of lines extending outward from a center side of the forming surface.

3. The method for manufacturing a glass material according to claim 1, wherein the gas jet holes are provided radially in the forming surface.

4. The method for manufacturing a glass material according to claim 1, wherein the gas jet holes in the forming surface are provided so that centers of the gas jet holes are located at each vertex of an equilateral triangle grid.

5. The method for manufacturing a glass material according to claim 1, wherein the gas jet holes have a diameter of 1 mm or less.

6. The method for manufacturing a glass material according to claim 1, wherein a forming die having the forming surface includes a porous body having interconnected pores and the gas jet holes are formed of the interconnected pores.

7. The method for manufacturing a glass material according to claim 6, wherein the forming die used is a forming die including the porous body and a gas barrier layer covering a lateral surface of the porous body.

8. The method for manufacturing a glass material according to claim 1, wherein the forming surface is provided in a concave spherical or concave aspherical shape having a central angle of 180° or less.

9. The method for manufacturing a glass material according to claim 1, wherein a proportion of area of the forming surface occupied by the gas jet holes is 0.1% or more.

10. The method for manufacturing a glass material according to claim 9, wherein the gas jet holes are provided only in a central region of the forming surface.

11. The method for manufacturing a glass material according to claim 9, wherein the gas jet holes in a central region of the forming surface are provided so that centers of the gas jet holes are located at each vertex of an equilateral triangle grid and the gas jet holes outside the central region of the forming surface are provided radially.
